(19) United States
(12) Patent Application Publication
(10) Pub. No.: US 2026/0343350 A1
(43) Pub. Date: Oct. 29, 2026

(54) CONNECTION ESTABLISHMENT AND RESUME IN MULTI-LAYERED NETWORKS

(71) Applicant: InterDigital Patent Holdings, Inc., Wilmington, DE (US)

(72) Inventors: Oumer Teyeb, Montreal (CA); Dylan Watts, Montreal (CA); Brian Martin, Farnham (GB)

(73) Assignee: InterDigital Patent Holdings, Inc., Wilmington, DE (US)

(21) Appl. No.: 19/101,528

(22) PCT Filed: Aug. 4, 2023
(86) PCT No.: PCT/US2023/029462

§ 371 Date: Feb. 5, 2025

Related U.S. Application Data
(60) Provisional application No. 63/395,543, filed on Aug. 5, 2022.

(51) Int. Cl. H04W 36/08; H04W 76/10

(52) U.S. Cl. CPC H04W 36/08; H04W 76/10

(57) ABSTRACT

Systems, methods, and instrumentalities are described herein for connection and establishment and resume in multi-layered networks. A wireless transmit/receive unit (WTRU) may be configured to associate with a first cell of a first network layer. The WTRU may receive configuration information indicating that the first network layer is associated with a first connection cause and a second network layer is associated with a second connection cause. The WTRU may determine to establish a connection and may determine an associated connection cause for establishing the connection. In examples, the associated connection cause may be the second connection cause. Based on the first cell being associated with the first connection cause, the second cell being associated with the second connection cause, and the second cell being available, the WTRU may perform cell re-selection to the second cell. The WTRU may establish the connection via the second cell.

### CROSS-REFERENCE TO RELATED APPLICATIONS

This application claims the benefit of Provisional U.S. Patent Application No. 63/395,543, filed Aug. 5, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for connection and establishment and resume in multi-layered networks.

A wireless transmit/receive unit (WTRU) may be configured to associate with (e.g., camp on) a first cell of a first network layer. The WTRU may camp on the first cell according to legacy cell re-selection behavior while in an RRC_IDLE/RRC_ACTIVE state. The WTRU may receive configuration information. The configuration information may indicate that the first network layer is associated with a first connection cause and a second network layer is associated with a second connection cause. In examples, the WTRU may be configured with a mapping of a connection cause value (e.g., a first connection cause value and a second connection cause value) and a preferred layer of the network (e.g., TN, LEO, MEO, GEO, etc.). In examples, the first network layer may be a non-terrestrial network (NTN) and the second network layer may be a terrestrial network (TN).

The WTRU may determine to establish a connection and may determine an associated connection cause for establishing the connection. In examples, establishing the connection may include establishing or resuming the connection. The associated connection cause may be related to at least one of: an emergency call; a mobile originated data call; a mobile originated voicecall; or a mobile originated SMS.

In examples, the associated connection cause may be the second connection cause. Based on the first cell being associated with the first network type and the first network type being associated with the first connection cause (e.g., the first cell does not belong to the preferred network type of the determined associated connection cause (e.g., the second connection cause)), the second cell being associated with the second network type and the second network being associated with the second connection cause (e.g., the second cell belongs to the preferred network type of the determined associated connection cause (e.g., the second connection cause)), and the second cell being available, the WTRU may perform cell re-selection to the second cell. The WTRU may (e.g., may then) establish the connection via the second cell.

The WTRU may be (e.g., may be further) configured to send an indication to the network regarding the cell re-selection that was performed. In examples, the indication may include information about the associated establishment cause and that the WTRU was camping on NTN and re-selected to TN due to the associated establishment cause. The information may be indicated in one or more of the following ways: in the setup/resume request message; in the setup/resume complete message; in an RRC message after the setup/resume is completed (e.g., WTRU assistance information); or in mobility history information (e.g., which may be sent to the network autonomously by the WTRU or requested from the network).

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a radio resource control (RRC) connection establishment, setup, and/or connection resume procedure from an idle state, which may be an RRC_IDLE state.

FIG. 3 illustrates an example of resuming an RRC connection from an inactive state, which may be an RRC_INACTIVE state.

FIG. 4 illustrates an example of different states, such as RRC states, and one or more transitions between them.

FIGS. 5A and 5B illustrate an example of cell selection and/or re-selection procedures in a network.

FIG. 6 illustrates an example of multiple interfaces in a network, which may be a non-terrestrial network.

FIG. 7 illustrates an example scenario where a WTRU may connect to multiple layers where the multiple layers may belong to one or more networks (e.g., a terrestrial network (TN) and several layers of NTNs

FIGS. 8-9 illustrate examples of cell re-selection based on an establishment cause.

### DETAILED DESCRIPTION

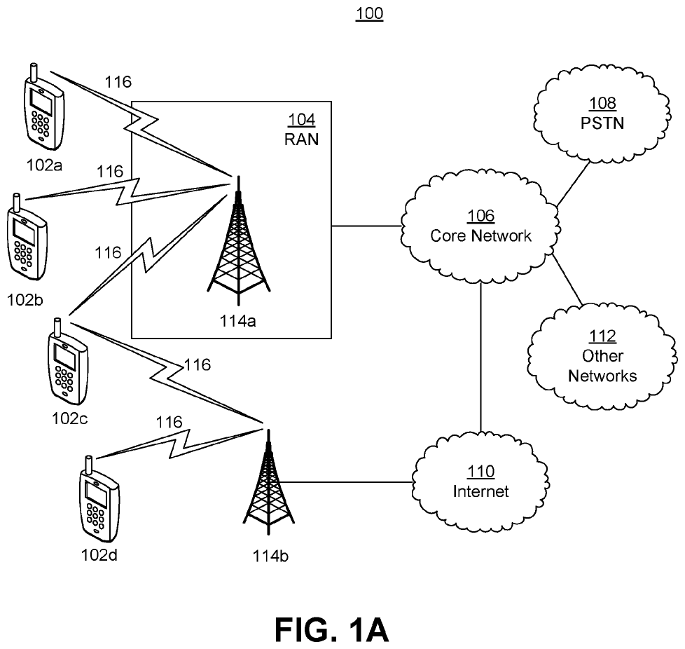

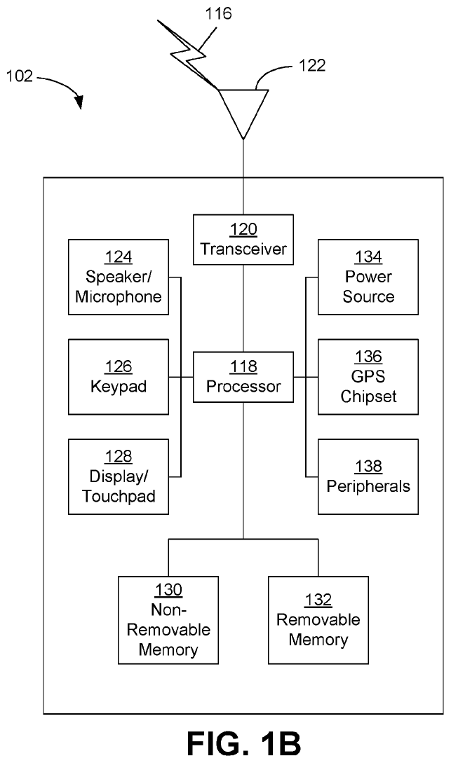

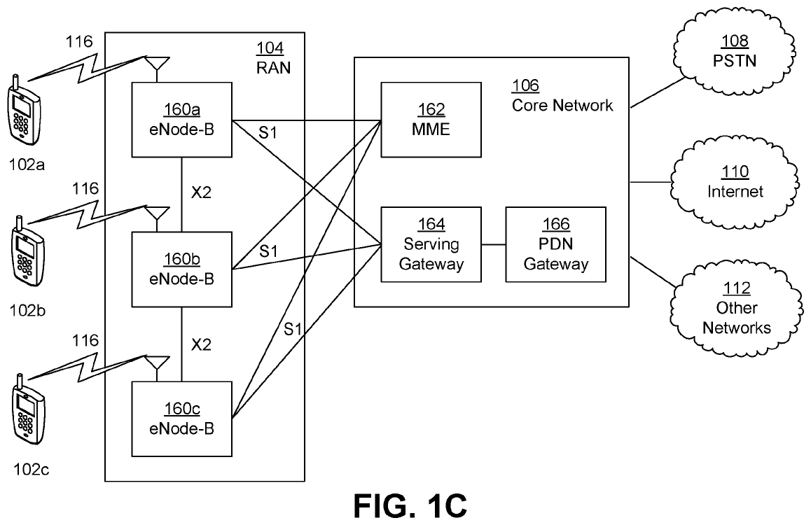

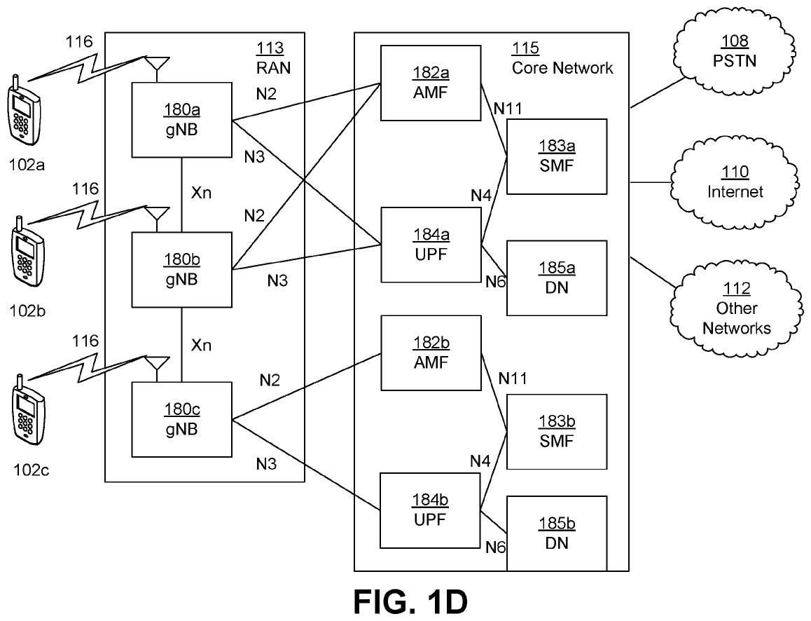

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a legacy technology or legacy handover, may indicate a legacy technology such as LTE compared to NR, or, a legacy version of a technology, for example an earlier version/release of a technology (e.g., earlier NR release) compared to a later version/release of the technology (e.g., later NR release).

Systems, methods, and instrumentalities are described herein for connection and establishment and resume in multi-layered networks.

A wireless transmit/receive unit (WTRU) may be configured to associate with (e.g., camp on) a first cell of a first network layer. The WTRU may camp on the first cell according to legacy cell re-selection behavior while in an RRC_IDLE/RRC_ACTIVE state. The WTRU may receive configuration information. The configuration information may indicate that the first network layer is associated with a first connection cause and a second network layer is associated with a second connection cause. In examples, the WTRU may be configured with a mapping of a connection cause value (e.g., a first connection cause value and a second connection cause value) and a preferred layer of the network (e.g., TN, LEO, MEO, GEO, etc.). In examples, the first network layer may be a non-terrestrial network (NTN) and the second network layer may be a terrestrial network (TN).

The WTRU may determine to establish a connection and may determine an associated connection cause for establishing the connection. In examples, establishing the connection may include establishing or resuming the connection. The associated connection cause may be related to at least one of: an emergency call; a mobile originated data call; a mobile originated voicecall; or a mobile originated SMS.

In examples, the associated connection cause may be the second connection cause. Based on the first cell being associated with the first network type and the first network type being associated with the first connection cause (e.g., the first cell does not belong to the preferred network type of the determined associated connection cause (e.g., the second connection cause)), the second cell being associated with the second network type and the second network being associated with the second connection cause (e.g., the second cell belongs to the preferred network type of the determined associated connection cause (e.g., the second connection cause)), and the second cell being available, the WTRU may perform cell re-selection to the second cell. The WTRU may (e.g., may then) establish the connection via the second cell.

The WTRU may be (e.g., may be further) configured to send an indication to the network regarding the cell re-selection that was performed. In examples, the indication may include information about the associated establishment cause and that the WTRU was camping on NTN and re-selected to TN due to the associated establishment cause. The information may be indicated in one or more of the following ways: in the setup/resume request message; in the setup/resume complete message; in an RRC message after the setup/resume is completed (e.g., WTRU assistance information); or in mobility history information (e.g., which may be sent to the network autonomously by the WTRU or requested from the network).

A WTRU may be configured to perform cell re-selection to a cell belonging to a network layer (e.g., terrestrial network (TN), non-terrestrial network (NTN), etc.) based on the connection establishment cause during connection setup. A WTRU may be configured to perform cell re-selection to a cell belonging to a network layer (e.g., TN, NTN, etc.) based on the connection resume cause during connection resume. A WTRU may be configured to perform cell re-selection to a cell belonging to a network layer (e.g., TN, NTN, etc.) based on the access category/identity cause during connection setup. A WTRU may be configured to perform cell re-selection to a cell belonging to a network layer (e.g., TN, NTN, etc.) based on the access category/identity cause during connection resume. A WTRU may be configured to perform simultaneous camping on multiple cells at different layers (e.g., TN, NTN, etc.). A WTRU may select/choose a cell that the WTRU is camping on based on the connection establishment/resume or access category/identity during connection setup/resume.

As used herein, “establishment” and “setup” may be used interchangeably. For example, a connection setup may be equivalent to a connection establishment, and vice versa. As another example, a setup cause may be equivalent to an establishment cause. As used herein, “establishment cause,” “connection cause,” and “connection establishment cause,” and “associated connection cause” may be used interchangeably. As used herein, “network layer” and “network type” may be used interchangeably. For example, a network type may be equivalent to a network layer and vice versa.

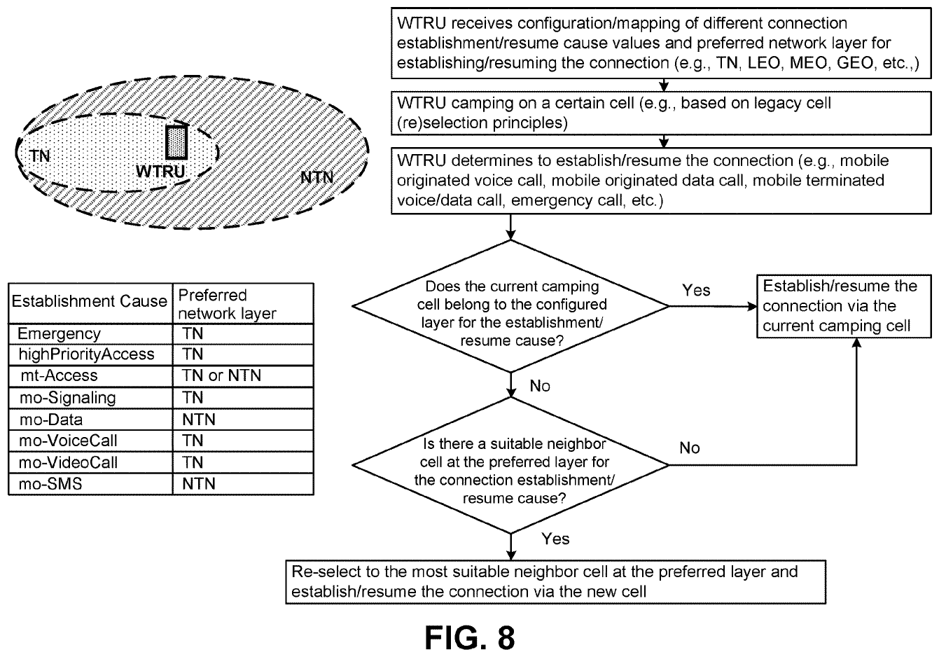

A WTRU (e.g., operating in RRC_IDLE/RRC_INACTIVE) may be capable of connecting to a multitude of cells associated with multi-layered networks (e.g., terrestrial networks, non-terrestrial networks, etc.) Each respective cell of the multitude of cells may be associated with a respective network layer (e.g., a first cell may be associated with a first network layer and a second cell may be associated with a second network layer). The WTRU may be (e.g., configured to) select a cell associated with a network layer during connection setup/resume (e.g., select the right cell/suitable cell) based on the suitability of a network layer/cell. The suitability of the network layer/cell may be based on the connection establishment/resume cause (e.g., connection cause) and/or access identity/category. For example, a WTRU may receive configuration information (e.g., a configuration/mapping) indicating a connection cause (e.g., establishment/resume cause (e.g., emergency, mo-Data, mo-VoiceCall, mo-SMS, etc.)), an access identity/category, and/or a network layer (e.g., TN, NTN, etc.). The configuration information may indicate that a respective network layer is associated with a respective connection cause (e.g., a first network layer is associated with a first connection cause and a second network layer is associated with a second connection cause), for example as described herein and shown in the figures (e.g., FIG. 8).

The WTRU may associate with (e.g., camp on) a cell (e.g., a first cell, for example a best cell). For example, the WTRU may camp on a cell (e.g., the first cell) according to legacy cell re-selection behavior (e.g., while in RRC_IDLE/RRC_INACTIVE). A connection may be set up or resumed, for example, due to UL data. An establishment cause may be determined for establishing a connection to a cell. The establishment cause may be a connection cause (e.g., the first connection cause or the second connection cause). The connection may be established/resumed via the current serving cell (e.g., first cell) by initiating the RACH procedure towards that cell, etc., if the current serving cell (e.g., first cell) belongs to a network layer (e.g., a first network) that is configured to be preferred for the connection establishment/resume cause (e.g., a first connection cause), access identity, and/or access category. A cell re-selection to a neighbor cell (e.g., a second cell) may be performed/established or the connection may be established/resumed (e.g., via the selected neighbor cell) if there is a suitable (e.g., available) neighbor cell (e.g., second cell) that belongs to the network layer (e.g., the second network layer) that is configured to be appropriate for a connection establishment/resume cause (e.g., a second connection cause) or access identity/category (e.g., as indicated in the configuration information). The connection may (e.g., otherwise) be established/resumed via the current serving cell (e.g., the first cell).

In examples, a WTRU operating in RRC_IDLE/RRC_INACTIVE may be capable of connecting to a multitude of multi-layered networks (e.g., terrestrial networks, non-terrestrial networks, etc.). The WTRU may (e.g., be configured to) camp on multiple cells of different layers at the same time (e.g., simultaneously). The WTRU may (e.g., be configured to) select a cell (e.g., the correct cell) amongst the multiple cells to use for connection setup/resume based on the connection establishment/resume cause and/or access identity/category.

Examples of connection states and/or state transmissions are provided herein. Examples of RRC connection states and state transitions are provided herein. In a network (e.g., a NR network), a WTRU may be in one or more states, such as in one of the following RRC states: RRC_CONNECTED (e.g., which may be referred to as “CONNECTED mode”); RRC_INACTIVE (e.g., which may be referred to as “INACTIVE mode”); and/or RRC_IDLE (e.g., which may be referred to as “IDLE mode”).

In a connected state, such as an RRC_CONNECTED state, a WTRU may be actively connected to the network, with signaling and data radio bearers established (e.g., SRB and DRBs). The WTRU may be able to receive downlink (DL) data from the network in a unicast fashion and/or may be able to send uplink (UL) data to the network. The mobility of the WTRU from one cell/node to another may be controlled by the network. The network may configure the WTRU to send measurement reports periodically or aperiodically (e.g., if conditions are fulfilled (e.g., a neighbor cell becomes better than a serving cell by more than a threshold)). The network may (e.g., based on the reports) send the WTRU a handover (HO) command to move the WTRU to another cell/node. The network may configure a conditional handover (CHO) where (e.g., instead of the sending of a measurement report) the WTRU may execute a preconfigured HO command if conditions are fulfilled. The network may send the WTRU an HO command without receiving a measurement report (e.g., based on implementation, such as the determination of current location).

Keeping the WTRU in connected mode may be power intensive for the WTRU (e.g., the WTRU may consume power by continuously monitoring the PDCCH of the serving cell (e.g., for determining the arrival of DL data, for UL data scheduling, etc.)). A cell/gNB may accommodate a number of WTRUs in connected mode (e.g., due to resource limitations). The network may send a WTRU to an inactive state (e.g., RRC_INACTIVE) or an idle state (e.g., RRC_IDLE state) if there is no activity in the UL or DL for a certain duration (e.g., based on an inactivity timer operated by the network).

The network may request that the WTRU be placed in an idle state, such as an RRC_IDLE state, if the network expects the WTRU to become inactive for a long duration. While in the inactive state (e.g., RRC_IDLE), the WTRU may associate with (e.g., camp on) a (e.g., the best) cell (e.g., the cell with the best signal level at the highest priority RAT and/or highest priority frequency within that RAT). The camping cell may facilitate the WTRU establishing a connection via the cell if a need arises for the WTRU to transition back to the connected state.

As described herein, a cell re-selection procedure may be provided and the cell re-selection procedure may be used to select a camping cell (e.g., the best camping cell) for the WTRU. The WTRU may monitor the downlink paging channel to detect DL data arrival. The WTRU may initiate the connection setup/establishment procedure if the WTRU detects a paging from the network indicating an arrival of DL data and/or if the WTRU needs to send UL data.

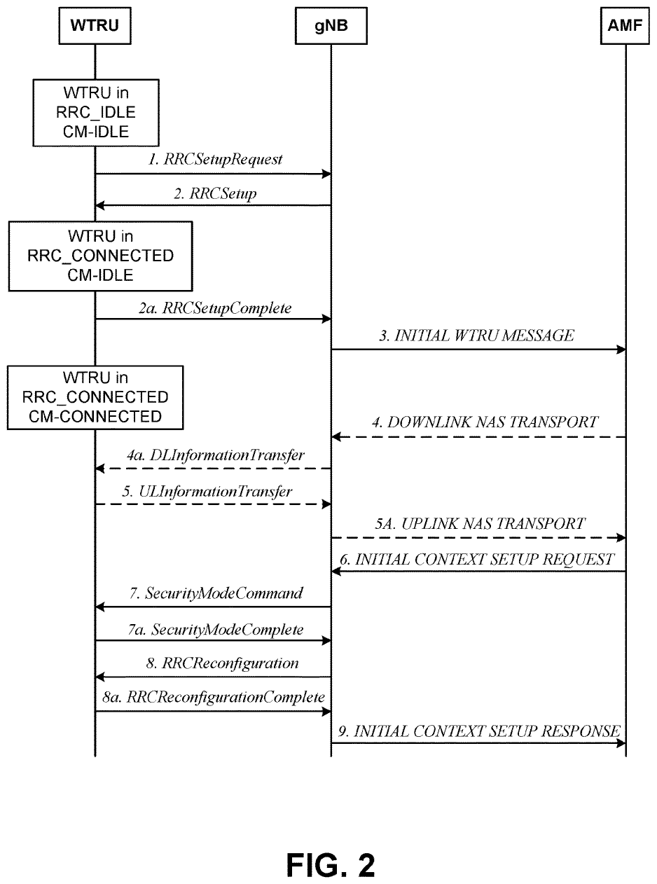

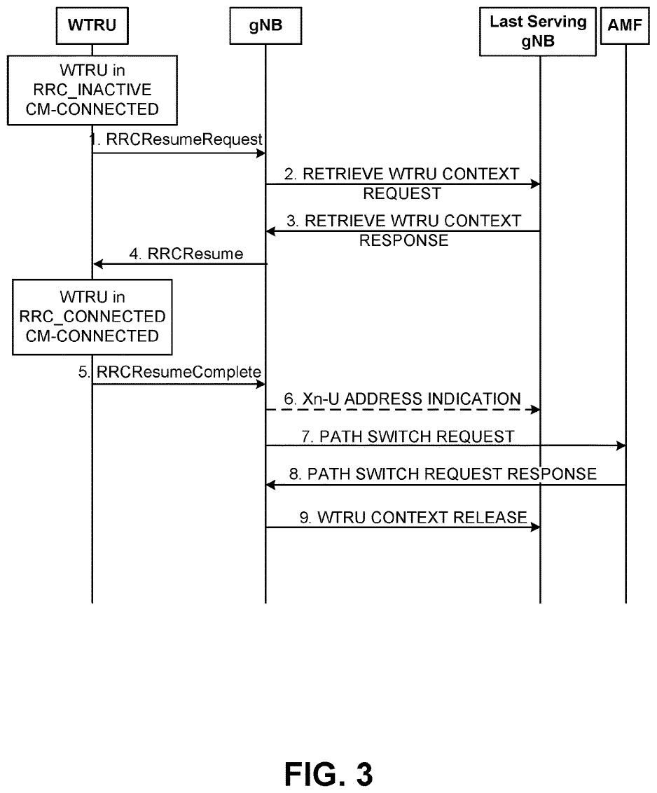

FIG. 2 illustrates an example of a radio resource control (RRC) connection establishment, setup, and/or connection resume procedure from an idle state, which may be an RRC_IDLE state. As shown in FIGS. 2 and 3, an RRC connection setup procedure may be a procedure that may include several round trips to complete and may involve a Core Network (CN). The WTRU's (e.g., UE's) RRC context may be released if the WTRU goes to IDLE mode. The WTRU may not be known at the RAN level. The RAN may have to fetch the WTRU context from the CN. Security may have to be re-established. The WTRU may be reconfigured with the DRBs and SRBs before UL/DL data transmission/reception may occur.

A lengthy setup procedure may not be compatible with low latency services. A network (e.g., NR network) may implement an intermediate state between the CONNECTED and IDLE state, which may be referred to as an INACTIVE state. The INACTIVE state may provide power savings. The INACTIVE state may provide the greatest power savings advantage of the IDLE state (e.g., WTRU may not continuously monitor the PDCCH, which may be one of the most power consuming procedures in the CONNECTED state). The INACTIVE state may allow the RAN to retain the WTRU's RRC/security context. The connection may be resumed quickly (e.g., without involving the CN, re-establishing the WTRU's security context, and reconfiguring the bearers) if the WTRU is to transition or is transitioning to the CONNECTED mode (e.g., due to the arrival of UL data and/or the reception of a paging indicating the arrival of DL data).

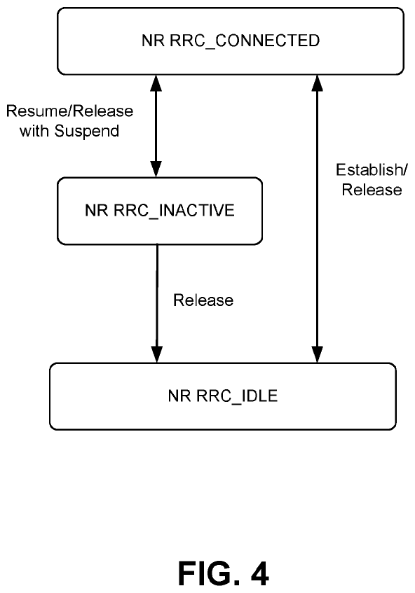

FIG. 3 illustrates an example of resuming an RRC connection from an inactive state, which may be an RRC_INACTIVE state. FIG. 4 illustrates an example of different states, such as RRC states, and one or more transitions between them.

An establishment cause and/or a resume cause (e.g., a connection cause) may be included if a WTRU performs a connection setup/establishment or resume procedure (e.g., the establishing the connection or resuming the connection). An establishment or resume cause may be included in the RRCSetupRequest or RRCResumeRequest. For example, the following causes may be provided to establish a connection and/or to resume a connection:

```
EstablishmentCause ::= ENUMERATED {
                        emergency, highPriorityAccess, mt-Access, mo-Signalling,
                        mo-Data, mo-VoiceCall, mo-VideoCall, mo-SMS,
                        mps-PriorityAccess, mcs-PriorityAccess, spare6, spare5,
                                                spare4, spare3, spare2, spare1}
ResumeCause ::= ENUMERATED {
                        emergency, highPriorityAccess, mt-Access, mo-Signalling,
                        mo-Data, mo-VoiceCall, mo-VideoCall, mo-SMS, rna-
                        Update, mps-PriorityAccess,mcs-PriorityAccess, spare1,
                        spare2, spare3, spare4, spare5}
```

In examples, a connection may be set up/resumed due to a voice call or video call originating from the WTRU. The WTRU may set the establishment/resume cause to mo-VoiceCall (e.g., mobile originated voice call) or mo-VideoCall (e.g., mobile originated video call). In examples, a connection may be set up/resumed due to downlink paging indicating DL data. The WTRU may set the establishment/resume cause to one of mt-Access (e.g., mobile terminated access), highPriorityAccess, mps-PriorityAccess, or mcs-PriorityAccess (e.g., depending on the access category of the WTRU).

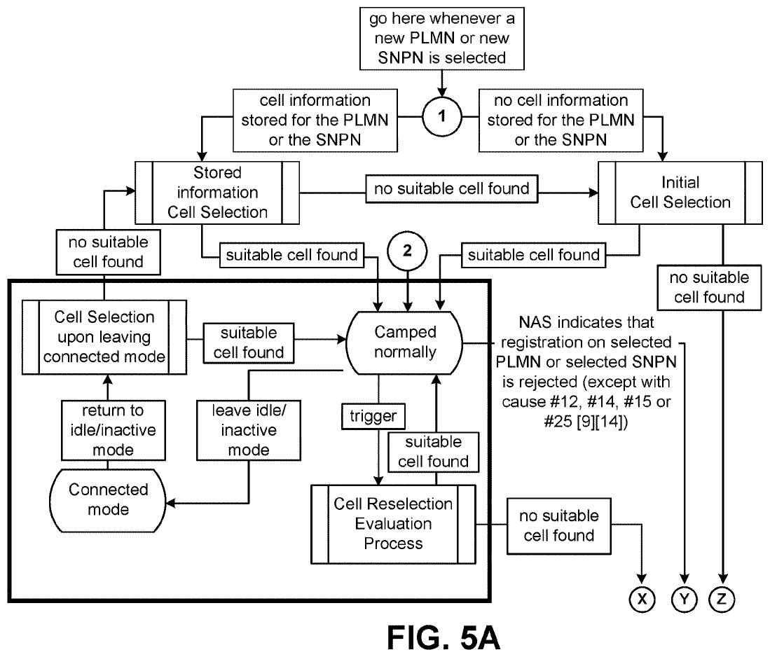

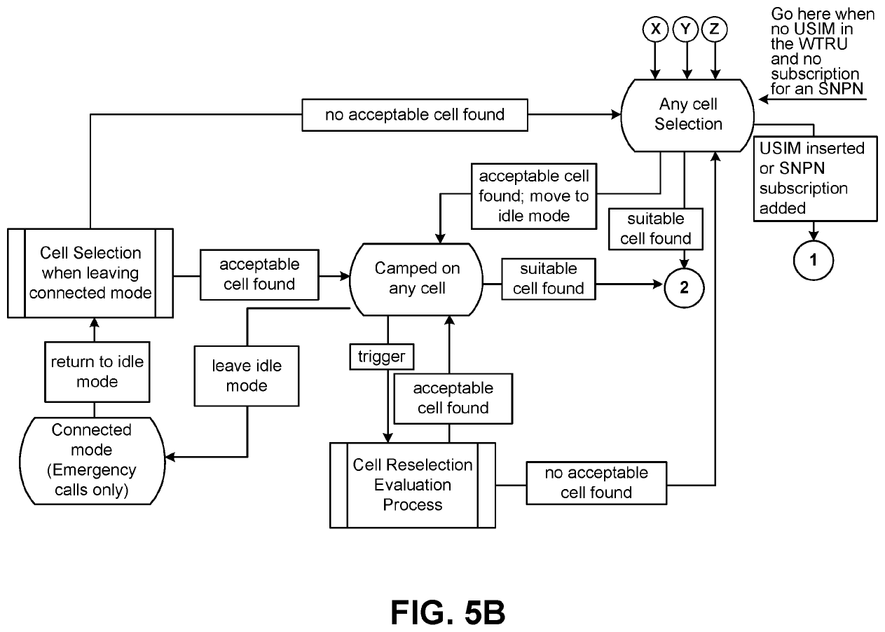

Mobility may be provided in RRC_IDLE/RRC_INACTIVE (Uu). A network (e.g., NR) cell selection/re-selection procedure may be complex as illustrated in FIGS. 5A and 5B. Some examples described herein may focus on the portion of the network cell selection/reselection procedure highlighted by the box in FIG. 5A, which covers aspects related to going from RRC_CONNECTED to RRC_IDLE/RRC_INACTIVE (e.g., if receiving an RRC Release message or transitory cell selection done during RRC re-establishment) (e.g., if a WTRU is able to find a suitable cell to camp on).

FIGS. 5A and 5B illustrate examples of cell selection and/or re-selection procedures in a network (e.g., NR network). Cell selection may include a WTRU that searches network (e.g., NR) frequency bands. A strong cell (e.g., the strongest cell) may be identified for one or more carrier frequencies (e.g., each carrier frequency) as per the CD-SSB. A WTRU may read cell system information broadcast to identify the PLMN(s) to find a suitable cell to camp on. A suitable cell may be a cell for which the measured cell attributes satisfy a cell selection criteria. The cell PLMN may be the selected PLMN, a registered PLMN, or an equivalent PLMN. The cell may not be barred or reserved. The cell may not be part of a tracking area in a list of forbidden tracking areas for roaming.

A WTRU may camp on a cell on a transition from a connected state (e.g., RRC_CONNECTED) or inactive state (e.g., RRC_INACTIVE) to an idle state (e.g., RRC_IDLE). A WTRU may camp on a cell as result of cell selection (e.g., according to the frequency assigned by RRC in a state transition message, if any).

The cell selection criterion (e.g., known as criterion S) may be fulfilled, for example, if:
Srxlev>0 AND Squal>0
   where:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ

Squal=Q_{qualmeas}−(Q_{qualmin}+Q_{qualminoffset})−Qoffsetₜₑₘₚ

where Table 1 describes examples of parameters for cell selection criterion:

TABLE 1
Example of parameters for cell selection criterion

| | |
|---|---|
| Srxlev | Cell selection RX level value (dB) |
| Squal | Cell selection quality value (dB) |
| Qoffsettₑₘₚ | Offset temporarily applied to a cell (dB) |
| Qᵣₓₗₑᵥₘₑₐₛ | Measured cell RX level value (e.g., RSRP) |
| Q_{qualmeas} | Measured cell quality value (e.g., RSRQ) |
| Qᵣₓₗₑᵥₘᵢₙ | Minimum RX level in the cell (dBm). If the WTRU supports SUL |
| | frequency for this cell, Qᵣₓₗₑᵥₘᵢₙ may be obtained from |
| | q-RxLevMinSUL, if present, in SIB1, SIB2 and SIB4, additionally, |
| | if Q_{rxlevminoffsetcellSUL} is present in SIB3 and SIB4 for the |
| | concerned cell, this cell specific offset may be added to the |
| | corresponding Qrxlevmin to achieve the minimum RX level in |
| | the concerned cell; else Qᵣₓₗₑᵥₘᵢₙ may be obtained from q- |
| | RxLevMin in SIB1, SIB2 and SIB4, additionally, if Q_{rxlevminoffsetcell} |
| | is present in SIB3 and SIB4 for the concerned cell, this cell |
| | specific offset may be added to the corresponding Qrxlevmin to |
| | achieve the minimum RX level in the concerned cell. |
| Q_{qualmin} | Minimum quality level in the cell (dB). Additionally, if |
| | Q_{qualminoffsetcell} is signaled for the concerned cell, this cell specific |
| | offset may be added to achieve the minimum quality level in the |
| | concerned cell. |
| Q_{rxlevminoffset} | Offset to the signalled Qᵣₓₗₑᵥₘᵢₙ taken into account in the Srxlev |
| | evaluation as a result of a periodic search for a higher priority |
| | PLMN while camped normally in a VPLMN. |
| Q_{qualminoffset} | Offset to the signalled Q_{qualmin} taken into account in the Squal |
| | evaluation as a result of a periodic search for a higher priority |
| | PLMN while camped normally in a VPLMN. |
| P_{compensation} | For FR1, if the WTRU supports the additionalPmax in the NR- |
| | NS-PmaxList, if present, in SIB1, SIB2 and SIB4: |
| | max(P_{EMAX1}-P_{PowerClass}, 0)-(min(P_{EMAX2}, P_{PowerClass})- |
| | min(P_{EMAX1}, P_{PowerClass})) (dB); |
| | else: |
| | max(P_{EMAX1}-P_{PowerClass}, 0) (dB) |
| | For FR2, P_{compensation} may be set to 0. |
| | For IAB-MT, P_{compensation} may be set to 0. |
| P_{EMAX1}, | Maximum TX power level of a WTRU may use when |
| P_{EMAX2} | transmitting on the uplink in the cell (dBm) defined as P_{EMAX}. If |
| | WTRU supports SUL frequency for this cell, P_{EMAX1} and P_{EMAX2} |
| | are obtained from the p-Max for SUL in SIB1 and NR-NS- |
| | PmaxList for SUL respectively in SIB1, SIB2 and SIB4, else |
| | P_{EMAX1} and P_{EMAX2} are obtained from the p-Max and NR-NS- |
| | PmaxList respectively in SIB1, SIB2 and SIB4 for normal UL. |
| P_{PowerClass} | Maximum RF output power of the WTRU (dBm) according to |
| | the WTRU power class. |

The signaled values Q_{rxlevminoffset} and Q_{qualminoffset} may (e.g., may only) be applied if a cell is evaluated for cell selection as a result of a periodic search for a higher priority public land mobile network (e.g., PLMN) while camped (e.g., normally) in a visiting public land mobile network (VPLMN). A WTRU may (e.g., during a periodic search for higher priority PLMN) check the S criteria of a cell using parameter values stored from a different cell of the higher priority PLMN.

Cell reselection may be performed by a WTRU in RRC_IDLE/RRC_INACTIVE. A WTRU may perform intra-frequency, inter-frequency, and/or inter-RAT cell re-selection.

A WTRU may be configured with priorities among one or more RATs (e.g., to prioritize camping on NR over LTE whenever an NR cell may be available) and/or among frequencies within the same RAT (e.g., fa may have a higher priority, fb may have a medium priority, fc may have a low priority, etc.). A neighbor cell list (NCL) may be provided to a WTRU. An NCL may indicate which neighbor cells (e.g., intra-frequency, inter-frequency, inter-RAT) may be considered for cell reselection. Allow-lists may be provided to the WTRU. An allow-list may indicate the neighboring cells that could be considered for re-selection. Exclude-lists may be provided to the WTRU. Exclude lists may indicate the neighboring cells that unsuitable for re-selection.

A WTRU may try to camp on a cell operating with the highest priority RAT and with the highest priority frequency.

The WTRU may choose not to perform intra-frequency measurements, for example, if the serving cell fulfils Srxlev>S_{intraSearchP} and Squal>S_{intraSearchQ}. The WTRU may (e.g., otherwise) perform intra-frequency measurements.

The WTRU may choose not to perform measurements of NR inter-frequency cells of equal or lower priority, or inter-RAT frequency cells of lower priority, for example, if the serving cell fulfils Srxlev>S_{nonIntraSearchP} and Squal>S_{nonIntraSearchQ}. The WTRU may (e.g., otherwise) perform measurements of network (e.g., NR) inter-frequency cells of equal or lower priority, and/or inter-RAT frequency cells of lower priority. Table 2 provides descriptions of parameters that may be used in measurement criteria.

TABLE 2
Example of parameters in measurement criteria

| | |
|---|---|
| S_{IntraSearchP} | Srxlev threshold (in dB) for intra-frequency |
| | measurements. |
| S_{IntraSearchQ} | Squal threshold (in dB) for intra-frequency |
| | measurements. |
| S_{nonIntraSearchP} | Srxlev threshold (in dB) for NR inter-frequency |
| | and inter-RAT measurements. |
| S_{nonIntraSearchQ} | Squal threshold (in dB) for NR inter-frequency |
| | and inter-RAT measurements. |

A WTRU may perform the cell rankings of the concerned cells if the WTRU decides to perform intra-frequency measurements for cell re-selection based on the criteria. Inter-frequency and/or inter-RAT reselection may be based on (e.g., absolute) priorities where a WTRU tries to camp on the highest priority frequency available.

A cell-ranking criterion (e.g., referred to us Criteria R) for serving cell (Rs) and for neighboring cells (Rn) may be defined by:

Rₛ=Q_{meas,s}+Q_{hyst}−Qoffsetₜₑₘₚ

Rₙ=Q_{meas,n}−Qoffset−Qoffsetₜₑₘₚ
where Table 3 provides example descriptions of parameters in cell ranking criterion:

TABLE 3
Example of parameters in cell ranking criterion

| | |
|---|---|
| Qₘₑₐₛ | RSRP measurement quantity used in cell reselections. |
| Qoffset | For intra-frequency: Equal to Qoffset_{s, n}, if Qoffset_{s, n} |
| | is valid, otherwise equal to zero. |
| | For inter-frequency: Equal to Qoffset_{s, n} plus Qoffset_{frequency}, |
| | if Qoffset_{s, n} is valid, otherwise equal to Qoffset_{frequency}. |
| Qoffsetₜₑₘₚ | Offset temporarily applied to a cell. |

A WTRU may perform a ranking of (e.g., all) cells that fulfil the cell selection criterion S (e.g., as described herein).

Cells may be ranked according to the R criteria (e.g., as described herein) by deriving Q_{meas,n} and Q_{meas,s} and calculating the R values using averaged RSRP results. The WTRU may perform cell reselection to the highest ranked cell if rangeToBestCell is not configured. The WTRU may perform cell reselection to the cell with a high number of beams (e.g., highest number of beams) above the threshold (e.g., absThreshSS-BlocksConsolidation) among the cells whose R value may be within rangeToBestCell of the R value of the highest ranked cell if rangeToBestCell is configured. The WTRU may perform cell reselection to a high ranked cell (e.g., the highest ranked cell) among multiple cells.

The WTRU may reselect to a cell (e.g., a new cell) if one or more of the following conditions are met: the new cell is better than the serving cell according to the cell reselection criteria (e.g., as described herein) during a time interval TreselectionRAT; or more than a threshold of time (e.g., 1 second) has elapsed since the WTRU camped on the current serving cell.

Non-Terrestrial Networks (NTN) may facilitate deployment of wireless networks in areas where land-based antennas are impractical, for example, due to geography or cost. NTNs coupled with TNs may enable ubiquitous network coverage (e.g., by 5G networks). NTN deployments may support basic talk and text anywhere in the world. NTN, TN and low-orbit satellites may enable enhanced services, such as web browsing for NTNs.

An NTN may include an aerial or space-borne platform which may (e.g., via a gateway (GW)) transport signals from a land-based based gNB to a WTRU and vice-versa. An NTN may support power class 3 WTRUs with omnidirectional antenna and linear polarization, and/or a (e.g., very) small aperture antenna (VSAT) terminal with directive antenna and circular polarization. Support for LTE-based narrow-band IoT (NB-IoT) and eMTC type devices may be supported by NTNs. NTN WTRUs may be GNSS capable.

Aerial or space-borne platforms may be classified in terms of orbit (e.g., low-earth orbit (LEO) satellites with an altitude range of 300-1500 km, geostationary earth orbit (GEO) satellites with an altitude at 35,786 km, medium-earth orbit (MEO) satellites with altitude range 7000-25000 km and high-altitude platform stations (HAPS) with an altitude of 8-50 km). Satellite platforms may be (e.g., further) classified as having a transparent or regenerative payload. Transparent satellite payloads may implement frequency conversion and RF amplification in uplink and/or downlink. Multiple transparent satellites may be connected to one land-based gNB. Regenerative satellite payloads may implement a full gNB or gNB DU onboard the satellite. Regenerative payloads may perform digital processing on signals (e.g., including demodulation, decoding, re-encoding, re-modulation and/or filtering).

One or more of the following radio interfaces may be defined (e.g., configured) in NTN: feeder-link (e.g., a wireless link between the GW and satellite); service link (e.g., a radio link between the satellite and WTRU); or inter-satellite link (ISL) (e.g., a transport link between satellites). An ISL may be supported (e.g., only) by regenerative payloads. An ISL may be a radio or proprietary optical interface.

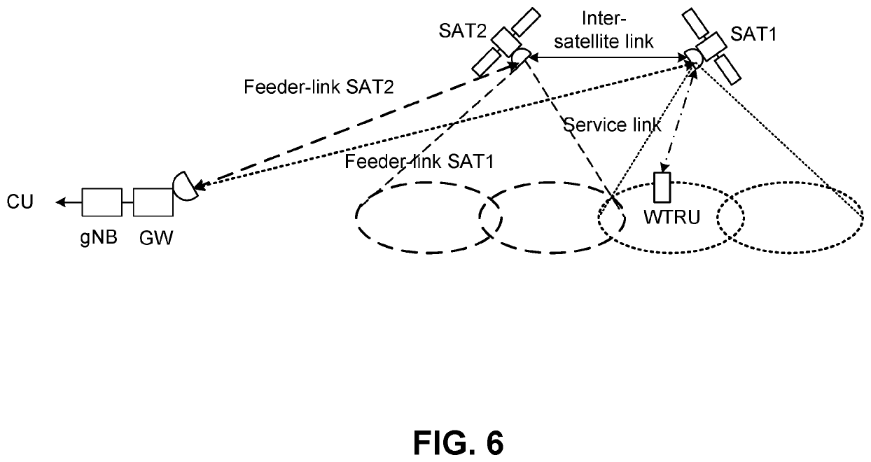

FIG. 6 illustrates an example depiction of multiple interfaces in a non-terrestrial network. An interface (e.g., different interfaces) may be used for a (e.g., each) radio link based on a satellite payload configuration. An NR-Uu radio interface may be used for a service link and/or a feeder-link (e.g., for a transparent payload). An NR-Uu interface may be used on the service link (e.g., for a regenerative payload). A satellite radio interface (SRI) may be used for the feeder-link (e.g., for a regenerative payload). A UP/CP protocol stack may be provided for a payload configuration (e.g., each payload configuration).

An NTN satellite may support multiple cells. A cell (e.g., each cell) may include one or more satellite beams. Satellite beams may cover a footprint on earth (e.g., like a terrestrial cell). Satellite beams may range in diameter from 100-1000 km in LEO deployments, and 200-3500 km diameter in GEO deployments. Beam footprints in GEO deployments may remain fixed relative to earth. The area covered by a beam/cell in LEO deployments may change over time (e.g., due to satellite movement). Beam movement may be classified as earth moving if the LEO beam moves continuously across the earth or earth fixed if the beam is steered to remain covering a fixed location until a cell (e.g., a new cell) overtakes the coverage area (e.g., in a discrete and coordinated change).

A round-trip time (RTT) and/or a maximum differential delay may be (e.g., significantly) larger for NTN platforms than for terrestrial systems due to the altitude of NTN platforms and/or due to beam diameter. In an example of a transparent NTN deployment, RTT may range from 25.77 ms (e.g., for LEO @ 600 km altitude) to 541.46 ms (e.g., for GEO), with a maximum differential delay from 3.12 ms to 10.3 ms. The RTT of a regenerative payload may be approximately half that of a transparent payload. A transparent configuration may include service and feeder links, whereas the RTT of a regenerative payload may consider (e.g., only) the service link. A WTRU may perform timing pre-compensation (e.g., prior to initial access) to reduce/minimize an impact to existing network (e.g., NR) systems (e.g., to avoid preamble ambiguity or to properly time reception windows).

A pre-compensation procedure may involve the WTRU obtaining its position (e.g., via GNSS), and/or the feeder-link (e.g., or common) delay and satellite position (e.g., via satellite ephemeris data). The satellite ephemeris data may be (e.g., periodically) broadcast in system information (SI). Satellite ephemeris data may include the satellite speed, direction, and/or velocity. The WTRU may estimate the distance (e.g., and thus delay) from the satellite. The WTRU may add the feeder-link delay component to obtain the WTRU-gNB RTT (e.g., the full WTRU-gNB RTT), which may be used to offset at least one of timers, reception windows, or timing relations. In some examples, frequency compensation may be performed by the network.

Examples of WTRU mobility and measurement reporting are provided herein. The difference in RSRP between a cell center and a cell edge may not be as pronounced in NTN as in terrestrial systems. Measurement-based mobility may become less reliable in an NTN environment (e.g., based on a much larger region of cell overlap). A network may utilize a conditional handover and measurement reporting triggers, which may rely on location and time. Enhanced mobility may be implemented in LEO deployments, where (e.g., due to satellite movement) a stationary WTRU may perform mobility (e.g., approximately every seven seconds), depending on deployment characteristics.

Examples of unified access control are provided herein. A WTRU may (e.g., if the WTRU initiates an access attempt) determine one or more access identities (e.g., from a set of standardized access identities) and an access category (e.g., from a set of standardized access categories and operator-defined access categories), which may be associated with the access attempt.

A set of access identities applicable for a request may be determined by a WTRU. Table 4 shows an example of access identities. For example, a WTRU may (e.g., for each of the access identities 1, 2, 3, 11, 12, 13, 14 and 15 shown by example in Table 4) check whether an access identity is applicable in a selected PLMN (e.g., if a new PLMN is selected), or, otherwise, check whether an access identity is applicable in the RPLMN or in an equivalent PLMN; and use access identity zero if none of the access identities is applicable.

TABLE 4
Example of access identities

| Access Identity | |
|---|---|
| number | UE configuration |
| 0 | UE may not be configured with any parameters |
| | from this table |
| 1 (NOTE 1) | UE may be configured for multimedia priority |
| | service (MPS). |
| 2 (NOTE 2) | UE may be configured for mission critical |
| | service (MCS). |
| 3 (NOTE 4) | UE for which a disaster condition applies |
| 4-10 | Reserved for future use |
| 11 (NOTE 3) | Access Class 11 may be configured in the UE. |
| 12 (NOTE 3) | Access Class 12 may be configured in the UE. |
| 13 (NOTE 3) | Access Class 13 may be configured in the UE. |
| 14 (NOTE 3) | Access Class 14 may be configured in the UE. |
| 15 (NOTE 3) | Access Class 15 may be configured in the UE. |

NOTE 1:
Access identity 1 may be valid when:
the USIM file EF_{UAC}_AIC indicates the UE may be configured for access identity 1 and the selected PLMN, if a new PLMN is selected, or RPLMN is the HPLMN (if the EHPLMN list may not be present or may be empty) or EHPLMN (if the EHPLMN list may be present), or a visited PLMN of the home country;
the UE may receive the 5GS network feature support IE with the MPS indicator bit set to “Access identity 1 valid” from the RPLM; or
the UE may receive the Priority indicator IE with the MPS indicator bit set to “Access identity 1 valid” from the RPLMN.
NOTE 2:
Access identity 2 may be used by UEs configured for MCS and may be valid when:
the USIM file EF_{UAC}_AIC indicates the UE may be configured for access identity 2 and the selected PLMN, if a PLMN (e.g., a new PLMN) may be selected, or RPLMN may be the HPLMN (if the EHPLMN list may not be present or may be empty) or EHPLMN (if the EHPLMN list may be present), or a visited PLMN of the home country; or
the UE may receive the 5GS network feature support IE with the MCS indicator bit set to “Access identity 2 valid” from the RPLMN.
NOTE 3:
Access identities 11 and 15 may be valid in HPLMN (if the EHPLMN list may not be present or may be empty) or EHPLMN (if the EHPLMN list may be present). Access Identities 12, 13 and 14 may be valid in HPLMN and visited PLMNs of home country.
NOTE 4:
Access Identity 3 may be valid when the UE may be registering or registered for disaster roaming services.

As indicated in Table 4, at NOTE 1, access identity 1 may be valid: (i) if the USIM file EFUAC_AIC indicates the WTRU is configured for access identity 1 and the selected PLMN, if another PLMN is selected (e.g., a new PLMN is selected), or RPLMN is the HPLMN (e.g., if the EHPLMN list is not present or is empty) or EHPLMN (e.g., if the EHPLMN list is present), or a visited PLMN of the home country; (ii) if the WTRU receives the 5GS network feature support IE with the MPS indicator bit set to “Access identity 1 valid” from the RPLMN; or (iii) if the WTRU receives the Priority indicator IE with the MPS indicator bit set to “Access identity 1 valid” from the RPLMN.

As indicated in Table 4, at NOTE 2, access identity 2 may be valid (e.g., and may be used by WTRUs configured for MCS) if: (i) the USIM file EFUAC_AIC indicates the WTRU is configured for access identity 2 and the selected PLMN, if a new PLMN is selected, or RPLMN is the HPLMN (e.g., if the EHPLMN list is not present or is empty) or EHPLMN (e.g., if the EHPLMN list is present), or a visited PLMN of the home country; or (ii) the WTRU receives the 5GS network feature support IE with the MCS indicator bit set to “Access identity 2 valid” from the RPLMN.

As indicated in Table 4, at NOTE 3, access identities 11 and 15 may be valid in HPLMN (e.g., if the EHPLMN list is not present or is empty) or EHPLMN (e.g., if the EHPLMN list is present) while access Identities 12, 13 and 14 may be valid in HPLMN and visited PLMNs of home country (e.g., only). As indicated in Table 4, at NOTE 4, access identity 3 may be valid if the WTRU is registering or registered for disaster roaming services.

Access identities may be mapped to an RRC establishment cause, for example, as shown in Table 5. Table 5 may show an example mapping table for access identities, access categories, and establishment causes. Table 5 may show an example mapping table for access identities/access categories and RRC establishment causes when establishing an N1 NAS signaling connection via NR connected to 5GCN.

TABLE 5
Example mapping table for access identities,
access categories and establishment cause

| | Access | | RRC establishment |
|---|---|---|---|
| Rule # | identities | Access categories | cause is set to |
| 1 | 1 | Any category | mps-PriorityAccess |
| 2 | 2 | Any category | mcs-PriorityAccess |
| 3 | 11, 15 | Any category | highPriorityAccess |
| 4 | 12, 13, 14, | Any category | highPriorityAccess |
| 5 | 0 | 0 (= MT_acc) | mt-Access |
| | | 1 (= delay tolerant) | Not applicable |
| | | | (NOTE 1) |
| | | 2 (=emergency) | emergency |
| | | 3 (= MO_sig) | mo-Signalling |
| | | 4 (= MO MMTel voice) | mo-VoiceCall |
| | | 5 (= MO MMTel video) | mo-VideoCall |
| | | 6 (= MO SMS and | mo-SMS |
| | | SMSoIP) | |
| | | 7 (= MO_data) | mo-Data |
| | | 9 (= MO IMS registration | mo-Data |
| | | related signalling) | |

NOTE 1:
A UE may be using access category 1 for the access barring check may determine a second access category in the range 3 to 7 that may be used for determination of the RRC establishment cause.
NOTE 2:
See Table 4 for use of the access identities of 0, 1, 2, and 11-15.

As shown in Table 5, at NOTE 1, a WTRU using access category 1 for an access barring check may determine a second access category in the range 3 to 7 that may be used for determination of the RRC establishment cause. In examples, access identifies of 0, 1, 2, and 11-15 may be those shown with respect to Table 4.

Table 6 shows an example mapping table for access categories.

TABLE 6
Example mapping table for access categories

| | | | Access |
|---|---|---|---|
| Rule # | Type of access attempt | Requirements to be met | Category |
| 1 | Response to paging or | Access attempt may be for MT access, or | 0 (= MT_acc) |
| | NOTIFICATION over non- | handover of ongoing MMTEL voice call, | |
| | 3GPP access; | MMTEL video call or SMSoIP from non- | |
| | 5GMM connection | 3GPP access; or | |
| | management procedure | Access attempt may be made upon receipt | |
| | initiated for the purpose of | of call-pull-initiated | |
| | transporting an LPP | | |
| | message without an | | |
| | ongoing 5GC-MO-LR | | |
| | procedure; | | |
| | Access attempt to | | |
| | handover of ongoing | | |
| | MMTEL voice call, | | |
| | MMTEL video call or | | |
| | SMSoIP from non-3GPP | | |
| | access; or | | |
| | Access attempt upon | | |
| | receipt of “call-pull- | | |
| | initiated” indication from | | |
| | the upper layers | | |
| 2 | Emergency | UE may be attempting access for an | 2 (= emergency) |
| | | emergency session (NOTE 1, NOTE 2) | |
| 3 | Access attempt for | UE may store operator-defined access | 32-63 |
| | operator-defined access | category definitions valid in the PLMN (e.g., | (= based on |
| | category | current PLMN), and access attempt may be | operator |
| | | matching criteria of an operator-defined | classification) |
| | | access category definition | |
| 3.1 | Access attempt for MO | UE may be in NB-N1 mode and may be | 10 (= MO |
| | exception data | allowed to use exception data reporting | exception data) |
| | | (e.g., the ExceptionDataReportingAllowed | |
| | | leaf of the NAS configuration MO or the | |
| | | USIM file EF_{NASCONFIG}), and access attempt | |
| | | may be for MO data or for MO signalling | |
| | | initiated upon receiving a request from upper | |
| | | layers to transmit user data related to an | |
| | | exceptional event. | |
| 4 | Access attempt for delay | (a) UE may be configured for NAS | 1 (= delay |
| | tolerant service | signalling low priority or UE supporting S1 | tolerant) |
| | | mode may be configured for EAB (see the | |
| | | “ExtendedAccessBarring” leaf of NAS | |
| | | configuration MO) where “EAB override” | |
| | | may not apply, and | |
| | | (b): the UE may have received one of | |
| | | the categories a, b, or c as part of the | |
| | | parameters for unified access control in the | |
| | | broadcast system information, and the UE | |
| | | may be a member of the broadcasted | |
| | | category in the selected PLMN or | |
| | | RPLMN/equivalent PLMN | |
| | | (NOTE 3, NOTE 5, NOTE 6, NOTE 7, | |
| | | NOTE 8) | |
| 5 | MO MMTel voice call | Access attempt may be for MO MMTel voice | 4 (= MO MMTel |
| | | call or for NAS signalling connection | voice) |
| | | recovery during ongoing MO MMTel voice | |
| | | call (NOTE 2) | |
| 6 | MO MMTel video call | Access attempt may be for MO MMTel video | 5 (= MO MMTel |
| | | call or for NAS signalling connection | video) |
| | | recovery during ongoing MO MMTel video | |
| | | call (NOTE 2) | |
| 7 | MO SMS over NAS or MO | Access attempt may be for MO SMS over | 6 (= MO SMS |
| | SMSoIP | NAS (NOTE 4) or MO SMS over SMSolP | and SMSoIP) |
| | | transfer or for NAS signalling connection | |
| | | recovery during ongoing MO SMS or | |
| | | SMSoIP transfer (NOTE 2) | |
| 7.1 | MO IMS registration | Access attempt may be for MO IMS | 9 (= MO IMS |
| | related signalling | registration related signalling (e.g., IMS | registration |
| | | initial registration, re-registration, | related |
| | | subscription refresh) or for NAS signalling | signalling) |
| | | connection recovery during ongoing | |
| | | procedure for MO IMS registration related | |
| | | signalling (NOTE 2a) | |
| 8 | UE NAS initiated 5GMM | Access attempt may be for MO signalling | 3 (= MO_sig) |
| | specific procedures | | |
| 8.1 | Mobile originated location | Access attempt may be for mobile originated | 3 (= MO_sig) |
| | request | location request (NOTE 9) | |
| 8.2 | Mobile originated | Access attempt may be for mobile originated | 3 (= MO_sig) |
| | signalling transaction | signalling transaction towards the PCF | |
| | towards the PCF | (NOTE 10) | |
| 9 | UE NAS initiated 5GMM | Access attempt may be for MO data | 7 (= MO_data) |
| | connection management | | |
| | procedure or 5GMM NAS | | |
| | transport procedure | | |
| 10 | An uplink user data packet | No further requests may be requested | 7 (= MO_data) |
| | may be sent for a PDU | | |
| | session with suspended | | |
| | user-plane resources | | |

NOTE 1:
This may include 5GMM specific procedures while the service is ongoing and 5GMM connection management procedures to establish a PDU session with request type = “initial emergency request” or “existing emergency PDU session”, or to re-establish user-plane resources for such a PDU session. This may further include the service request procedure initiated with a SERVICE REQUEST message with the Service type IE set to “emergency services fallback”.
NOTE 2:
Access for the purpose of NAS signalling connection recovery during an ongoing service, or for the purpose of NAS signalling connection establishment following fallback indication from lower layers during an ongoing service may be mapped to the access category of the ongoing service in order to derive an RRC establishment cause but barring checks may be skipped for this access attempt.
NOTE 2a:
Access for the purpose of NAS signalling connection recovery during an ongoing procedure for MO IMS registration related signalling, or for the purpose of NAS signalling connection establishment following fallback indication from lower layers during an ongoing procedure for MO IMS registration related signalling, may be mapped to the access category of the MO IMS registration related signalling in order to derive an RRC establishment cause, but barring checks may be skipped for this access attempt.
NOTE 3:
If the UE selects a PLMN (e.g., a new PLMN), the selected PLMN may be used to check the membership; otherwise, the UE may use the RPLMN or a PLMN equivalent to the RPLMN.
NOTE 4:
This may include the 5GMM connection management procedures that may be triggered by the UE-initiated NAS transport procedure for transporting the MO SMS.
NOTE 5:
The UE configured for NAS signalling low priority may not be supported. If a UE supporting both S1 mode and N1 mode may be configured for NAS signalling low priority in S1 mode, the UE may ignore the configuration for NAS signalling low priority when in N1 mode.
NOTE 6:
If the access category applicable for the access attempt is 1, then the UE may determine a second access category from the range 3 to 7. If more than one access category matches, the access category of the lowest rule number may be chosen. The UE may use the second access category only to derive an RRC establishment cause for the access attempt.
NOTE 7:
“EAB override” may not apply, if the UE may not be configured to allow overriding EAB (e.g., the Override_ExtendedAccessBarring leaf of NAS configuration MO), or if NAS may not have received an indication from the upper layers to override EAB and the UE may not have a PDU session that was established with EAB override.
NOTE 8:
Categories a, b and c may be associated with access category 1. The categories associated with access category 1 may be different from the categories a, b and c associated with EAB.
NOTE 9:
This may include:
a) the UE-initiated NAS transport procedure for transporting a mobile originated location request;
b) the 5GMM connection management procedure triggered by a) above; and
c) NAS signalling connection recovery during an ongoing 5GC-MO-LR procedure.
NOTE 10:
This may include:
a) the UE-initiated NAS transport procedure for transporting a mobile originated signalling transaction towards the PCF;
b) the 5GMM connection management procedure triggered by a) above; and NAS signalling connection recovery during an ongoing UE-requested policy provisioning
c) procedure for V2XP, ProSeP or both.

As shown in Table 6, at NOTE 1, MM procedures, such as 5GMM procedures may be provided while the service may be ongoing and connection management procedures (e.g., 5GMM connection management procedures) to establish a PDU session with request type=“initial emergency request” or “existing emergency PDU session”, or to re-establish user-plane resources for such a PDU session. This may include a service request procedure initiated with a SERVICE REQUEST message with the service type IE set to “emergency services fallback.”

As shown in Table 6, at NOTE 2, access (e.g., for the purpose of NAS signaling connection recovery during an ongoing service, or for the purpose of NAS signaling connection establishment following fallback indication from lower layers during an ongoing service) may be mapped to the access category of the ongoing service (e.g., to derive an RRC establishment cause, but barring checks may be skipped for this access attempt).

As shown in Table 6, at NOTE 2a, access (e.g., for the purpose of NAS signaling connection recovery during an ongoing MO IMS registration related signaling, or for the purpose of NAS signaling connection establishment following fallback indication from lower layers during an ongoing MO IMS registration related signaling) may be mapped to the access category of the MO IMS registration related signaling (e.g., to derive an RRC establishment cause, but barring checks, may be skipped for this access attempt).

As shown in Table 6, at NOTE 3, the selected SNPN may be used to check the membership if the WTRU selects a new SNPN and, otherwise, the WTRU may use the RSNPN.

As shown in Table 6, at NOTE 4, the connection management procedures (e.g., 5GMM connection management procedures) may be triggered by the WTRU-initiated NAS transport procedure for transporting the MO SMS.

As shown in Table 6, at NOTE 5, a WTRU may be configured for NAS signaling low priority may not be supported. If the WTRU supporting both S1 mode and N1 mode is configured for NAS signaling low priority in S1 mode, the WTRU may ignore the configuration for NAS signaling low priority if in N1 mode.

As shown in Table 6, at NOTE 6, the WTRU may (e.g., additionally) determine a second access category from the range 3 to 7 if the access category applicable for the access attempt is 1. The access category of the lowest rule number may be selected if more than one access category matches. The WTRU may use a second access category (e.g., only) to derive an RRC establishment cause for the access attempt.

As shown in Table 6, at NOTE 7, an EAB override may not apply. For example, EAB override may not apply if the WTRU may not be configured to allow overriding EAB (e.g., the Override_ExtendedAccessBarring leaf of NAS configuration MO). As another example, EAB override may not apply if NAS may not have received an indication from the upper layers to override EAB and the WTRU may not have a PDU session that was established with EAB override.

As shown in Table 6, at NOTE 8, the categories associated with access category 1 may be distinct from the categories a, b and c associated with EAB.

As shown in Table 6, NOTE 9, one or more of the following may be included: the WTRU-initiated NAS transport procedure for transporting a mobile originated location request; a connection management procedure (e.g., the 5GMM connection management procedure) triggered by the WTRU-initiated NAS transport procedure; or NAS signaling connection recovery during an ongoing 5GC-MO-LR procedure.

As shown in Table 6, NOTE 10, one or more of the following may be included: the WTRU-initiated NAS transport procedure for transporting a mobile originated signaling transaction towards the PCF; the 5GMM connection management procedure triggered by the WTRU-initiated NAS transport procedure; or NAS signaling connection recovery during an ongoing WTRU-requested policy provisioning procedure for V2XP or both.

A procedure for unified access control may be used to perform an access barring check for an access attempt associated with a given access category and one or more access identities if requested from upper layers or the RRC layer.

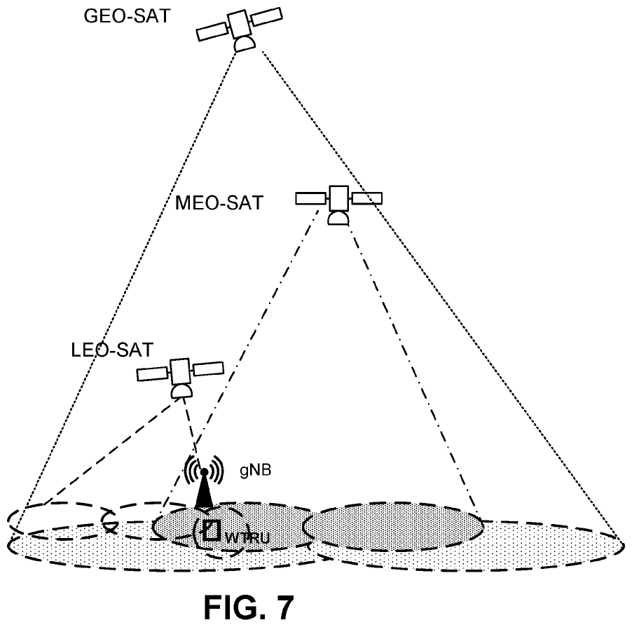

FIG. 7 illustrates an example scenario where a WTRU may connect to multiple layers of networks (e.g., a terrestrial network (TN) and several layers of NTNs). Cell re-selection (e.g., as described herein) may enable the WTRU to associate with (e.g., camp on) a cell that may have a high priority RAT and/or frequency (e.g., the best cell in the highest priority RAT and frequency), which may allow the WTRU to establish/resume the connection from that cell. This may lead to sub-optimal operations if a WTRU may be in the coverage area of multiple layers of networks (e.g., terrestrial, LEO satellites, MEO satellites, GEO satellites, etc.). A layer (e.g., each layer) may have (e.g., considerably) different characteristics (e.g., latency). For example, camping on an NTN cell may lead to a lower number of cell re-selections and fewer measurements from a WTRU while the WTRU is in IDLE/INACTIVE mode. It may be suboptimal to start a connection via an NTN cell if the latency requirement is strict (e.g., voice call, URLLC service, etc.). Camping (e.g., always) on a TN cell (e.g., a small cell at FR2 frequency) may lead to faster connection setup/resume but may lead to large number of cell re-selection and frequent measurements of neighbor cells.

A (e.g., an optimal) connection setup/resume mechanism may be enabled in multi-layered networks based on the strength of the camping/serving cell and prioritized RAT/frequency and/or based on the suitability of a network/cell for the cause of establishing/resuming the connection.

The terms RRC_CONNECTED state, connected mode, and connected state may be used interchangeably. The terms RRC_INACTIVE state, inactive mode, and inactive state may be used interchangeably. The terms RRC_IDLE, idle mode, and idle state may be used interchangeably.

The term “a WTRU camping on a cell” may refer to a WTRU in an IDLE/INACTIVE mode that may be performing a paging or monitoring on the cell and/or (e.g., also) may be performing cell re-selection measurements and/or cell re-selections that may be dependent on the current signal level of the cell.

Terms such as “establish the connection via a given cell” or “resume the connection via a given cell” may indicate that the WTRU may perform an initial access procedure (e.g., random access procedure) towards the cell.

The term “network type” may be used to distinguish between different types of networks, TN cells/nodes, and/or different kinds of NTN cells/nodes.

Although examples described herein may be focused on the differentiation of behavior towards TN and NTN, the examples (e.g., procedures/methods) may be (e.g., equally) applicable to other scenarios, such as where the differentiation is based on other aspects (e.g., operating frequencies, bandwidths available, load, etc.). A WTRU may determine a differentiation aspect (e.g., from the broadcasted information of the concerned cells) in other scenarios.

Although examples focus on WTRU initiated connection establishment/resume (e.g., arrival of UL data, WTRU initiated voice/video call, etc.), the examples (e.g., procedures/methods) may be (e.g., equally) applicable to the DL case. A paging indicator may include prioritization information (e.g., for DL examples).

Connection establishment and/or resume causes may be mapped to types of networks. In some examples, a WTRU may be configured with a mapping of a connection establishment cause value and the preferred layer of the network (e.g., TN, LEO, MEO, GEO, etc.). Table 7 illustrates an example mapping of establishment causes to preferred network types.

TABLE 7
Example mapping of establishment causes to preferred network types

| Establishment Cause | Preferred network type |
|---|---|
| Emergency | TN |
| highPriorityAccess | TN |
| mt-Access | TN or NTN |
| mo-Signaling | TN |
| mo-Data | NTN |
| mo-VoiceCall | TN |
| mo-VideoCall | TN |
| mo-SMS | NTN |

The example in Table 7 shows two types of networks (e.g., TN and NTN, for the sake of simplicity). In examples, the network may provide a mapping of different types of NTN. For example, mo-Data may be mapped to LEO, while mo-SMS may be mapped to GEO.

In some examples, a mapping for an establishment cause maybe the network layer of a current camping cell. For example, the current camping cell may be used based on the establishment cause, regardless of the layer the current camping cell belongs to.

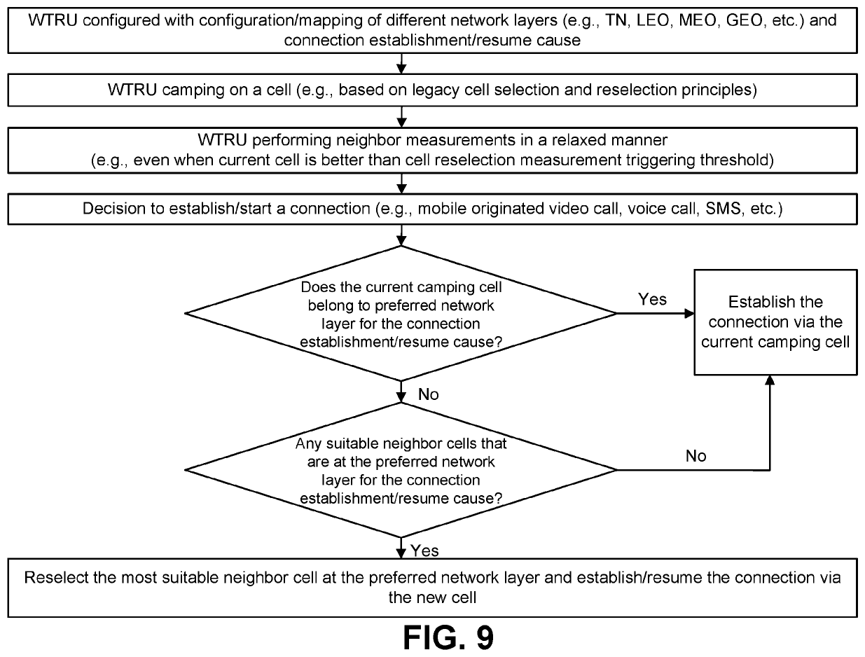

FIGS. 8-9 illustrate examples of cell re-selection based on an establishment cause. A WTRU may receive configuration information indicating network layers associated with respective connection causes (e.g., a first network layer associated with a first connection cause and a second network layer associated with a second connection cause). In examples, a WTRU may be configured with a mapping of a connection cause (e.g., a connection resume cause value) and a preferred layer of the network (e.g., TN, LEO, MEO, GEO, etc.). In examples, a mapping for a connection establishment and a mapping for a connection resumption may be the same. In examples, a mapping for a connection establishment and a mapping for a connection resumption may be different. A WTRU may (e.g., if the connection is setup or resumed) determine an establishment cause (e.g., establishment/resume cause). The establishment cause may be the first connection cause or the second connection cause (e.g., the WTRU may determine the establishment cause to be the first connection cause or the second connection cause). The WTRU may determine a preferred cell/network layer to connect to based on a mapping (e.g., configuration information), for example, the mapping may indicate that a first network layer is a preferred network type for a first connection cause and a second network layer is a preferred network type for a second connection cause.

In examples, the WTRU may determine the establishment cause is the first connection cause. Based on the first connection cause being associated with the first network layer and the first network layer being associated with a first cell, the WTRU may perform a connection establishment/resume via the current cell (e.g., first cell) it is associated with (e.g., camping on). For example, the WTRU may be camping on an NTN cell and determine the establishment/resume cause is the first connection cause. The WTRU may perform an establishment/resume via the NTN cell based on the establishment/resume cause being the first connection cause (e.g., mo-SMS, which may be mapped to NTN (e.g., in configuration information, for example as shown in Table 7)).

In examples, the WTRU may determine the establishment cause is the second connection cause. Based on the second connection cause being associated with the second network layer and the second network layer being associated with a second cell, the WTRU may try to find the second cell that belongs to the second network layer. If the second cell is available (e.g., found) at the preferred network type (e.g., the second network layer), the WTRU may perform cell re-selection towards the second cell and may establish/resume the connection via the second cell. If the second cell is not found at the second network layer, the WTRU may perform the connection establishment/resume via the current cell (e.g., first cell) it may be associated with (e.g., may be camping on).

In examples, the WTRU may (e.g., if trying to find a suitable cell at the preferred layer) not perform a comparison of the current camping cell and/or the neighbor cells at the preferred layer. For example, the WTRU may try to find the best cell at the preferred layer that also satisfies the S-criteria.

In examples, the WTRU may (e.g., if trying to find a suitable cell at the preferred layer) perform a comparison of the current camping cell and the neighbor cells at the preferred layer. The WTRU may (e.g., be further configured to) apply an offset on top of the signal levels of the neighbor cells at the preferred layer. The WTRU may re-select to a cell of the preferred layer if the signal strength of the concerned cells plus the offset is better than the serving cell (e.g., by more than a threshold).

An access category and/or an identity may be mapped to a type of network. In examples, a WTRU may be configured to use the access category as an alternative to or in addition to the establishment cause. Access categories may be defined (e.g., configured) by a core network (e.g., 5GC), and may be mapped to the establishment cause. A mapping of network type(s) may be made according to access category, access identity, a combination thereof, etc.

The broadcast unified access control parameters (e.g., barring bits and rules that a WTRU may check before making an access attempt) may correspond to access categories and/or access identities. An access category may be defined/customized (e.g., in the range 32-62) by an operator.

In examples, a WTRU may be configured with one or more RAT selection rules, which may be based on unified access control. For example, a WTRU may determine whether an access may be barred on the cell (e.g., current cell) for an access category and/or access identity (e.g., the current access category and access identity). The WTRU may perform a RAT change (e.g., from NTN to TN) to make the access attempt if barred. The cell (e.g., current cell) may broadcast a RAT preference for one or more access categories and/or access identities. For example, a custom access category 32 may be defined/configured. A RAT preference (e.g., TN, or NTN) may be broadcast for the category. A WTRU may initiate a service using the access category (e.g., 32). The WTRU may check the RAT preference (e.g., broadcast in system information). The WTRU may attempt to initiate the service according to the broadcast preference.

In examples, the current cell may broadcast UAC parameters for neighbor cells (e.g., UAC parameters applicable on another network). In examples, an access identity and/or access category may be indicated as barred on a cell (e.g., the current cell), but may not be indicated as barred on another cell. The WTRU may attempt to initiate the service on the other cell on which the access identity and/or access category are not barred.

Examples of prioritized mapping are provided herein. In examples, the WTRU may be configured with prioritized mapping (e.g., instead of 1:1 mapping). For example (e.g., for a given establishment/resume cause), the WTRU may be configured with a mapping, such as: {GEO, MEO, LEO, TN}. The mapping may indicate that the WTRU may attempt to find a suitable cell at the GEO level (e.g., which may assume that the current camping cell is not GEO), then (e.g., if a suitable cell is not found at the GEO level) the WTRU may attempt to find a suitable cell at the MEO level, and so on.

Examples of multi-layer camping are provided herein. In examples, a WTRU may be configured to perform cell selection/re-selection at one or more layers (e.g., different layers simultaneously). The WTRU may identify a cell for a layer. For example, the WTRU may identify a cell for each layer (e.g., the best cell at each layer). For example, the WTRU may (e.g., if the WTRU goes to IDLE or INACTIVE) perform cell selection for a layer (e.g., each layer) to identify one or more cells for the layer (e.g., the best cells at each layer). The WTRU may perform cell re-selection at each layer independently. At any given time, the WTRU may be assumed to be camping at different layers and may be assumed to be camping at the different layers simultaneously. The WTRU may (e.g., if a connection is to be established/resumed) check the mapping of the establishment/resume cause and establish/resume connection via a camping cell (e.g., the current camping cell) that corresponds to the preferred network layer.

Measurement behavior during IDLE/INACTIVE mode may be configured for camping at multiple layers.

For example, cell reselection (e.g., legacy cell reselection) may be based on the following: a WTRU may choose not to perform measurements of NR inter-frequency cells of equal or lower priority, or inter-RAT frequency cells of lower priority if the serving cell fulfills Srxlev>S_{nonIntraSearchP} and Squal>S_{nonIntraSearchQ}. The WTRU may (e.g., otherwise) perform measurements of inter-frequency cells (e.g., NR inter-frequency cells) of equal or lower priority and/or inter-RAT frequency cells of lower priority.

The criteria for not performing inter-frequency neighbor cells may be applicable (e.g., only applicable) to frequencies that are at the same layer (e.g., in support of multi-layered camping).

In examples, an inter-frequency measurement for the sake of multi-layer camping (e.g., which may not otherwise be performed if the serving cell is in good radio conditions) may be performed in a relaxed manner (e.g., WTRU taking the measurement samples of neighboring cells less periodically, etc.).

Multi-layer camping may be beneficial in the sense that the WTRU may have already identified the cell (e.g., the best cell) at multiple (e.g., all) layers by the time the connection is to be established/resumed. Multi-layer camping may lead to latency reduction (e.g., as compared to the WTRU performing cell re-selection after the WTRU identified the proper network layer). A WTRU may perform more neighbor cell measurements to perform multi-layer camping, which may (e.g., at least partially) counteract power savings by sending the WTRU to IDLE/INACTIVE mode.

In examples, a WTRU may be configured to use multi-layer camping (e.g., rather than single-layer/one-layer camping) (e.g., with cell re-selection based on a WTRU battery level (e.g., the current WTRU battery level). For example, the WTRU may be configured to use multi-layer camping if the WTRU battery level is above a threshold level, and use single-layer camping (e.g., with cell re-selection during the connection establishment/resumption if the battery level is below the threshold level).

A mapping between a connection establishment/resume cause or access category/identity and type of network may be provided (e.g., signaled) to a WTRU. In examples, the mapping of the type of network(s) and the establishment/resume cause may be provided to the WTRU (e.g., in the RRC Release message) if the WTRU is sent to IDLE or INACTIVE mode.

In examples, the mapping may be provided to the WTRU in a message (e.g., RRC Reconfiguration, MAC CE, etc.) while the WTRU is in CONNECTED state (e.g., before the WTRU is sent to IDLE or INACTIVE state using RRC Release). Mapping provided while a WTRU is in CONNECTED mode or during a transition to IDLE/INACTIVE may be referred to as dedicated mapping.

In examples, a mapping may be provided to a WTRU via broadcast signaling while the WTRU is in IDLE or INACTIVE state (e.g., in the SIB of the current cell).

In examples, a WTRU may be provided with a dedicated mapping before/during transition to an IDLE or INACTIVE state (e.g., RRC reconfiguration, RRC release, etc.). The WTRU may (e.g., also) determine that there is broadcast information regarding the mapping while the WTRU is in IDLE or INACTIVE state. The WTRU may perform one or more of the following: a WTRU may use a dedicated mapping configuration received before/during going to IDLE/INACTIVE and ignore the broadcasted information; a WTRU may use the broadcasted information and ignore/delete the dedicated mapping configuration received before/during the transition to IDLE/INACTIVE; or a WTRU may use the intersection of the information between the dedicated mapping configuration and the broadcasted information (e.g., the WTRU may map information that is the same in the dedicated and broadcasted configuration).

A WTRU may use the union of the information between the dedicated mapping configuration and the broadcasted information.

In examples, dedicated mapping may be prioritized. Dedicated mapping may be NTN for an establishment/resume cause while broadcast mapping may be TN for the same establishment/resume cause. The WTRU may (e.g., first) try to find a suitable cell at the NTN level (e.g., assuming the current camping cell is not NTN). The WTRU may (e.g., then) try to find a suitable cell at the TN level (e.g., if a suitable cell is not found at the NTN level).

In examples, broadcasted mapping may be prioritized. Broadcast mapping may be NTN for an establishment/resume cause while dedicated mapping may be TN for the same establishment/resume cause. The WTRU may (e.g., first) try to find a suitable cell at the NTN level (e.g., assuming the current camping cell is not NTN). The WTRU may (e.g., may then) try to find a suitable cell at the TN level (e.g., if such a suitable cell is not found at the NTN level).

In examples, a WTRU implementation may determine whether to prioritize dedicated mapping or broadcasted mapping. Signaling may (e.g., also) be applicable to mapping between access category/identity and type of network.

A WTRU may inform a network about a cell re-selection choice during setup/resume. In examples, a WTRU may be configured to send an indication to the network regarding cell re-selection that was performed (e.g., just) before setup/resume. For example, the WTRU may include the determined establishment cause and information during the establishment/resume procedure that the WTRU was camping on a first cell associated with a first network layer (e.g., a NTN) and re-selected to a second cell associated with a second network layer (e.g., TN) due to the establishment/resume cause (e.g., the determined establishment cause being the second connection cause associated with the second network layer). The information may be indicated in one or more of the following ways: in the setup/resume request message; in the setup/resume complete message; in an RRC message after the setup/resume is completed (e.g., WTRU assistance information); or in mobility history information (e.g., which may be sent to the network autonomously by the WTRU or if requested from the network).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-14. (canceled)

15. A wireless transmit/receive unit (WTRU), the WTRU comprising:
a processor configured to:
determine that the WTRU is associated with a first cell of a first network layer;
receive configuration information, wherein the configuration information indicates that the first network layer is associated with a first connection cause and a second network layer is associated with a second connection cause;
determine to establish a connection based on a detection of an establishment cause, wherein the detected establishment cause is the second connection cause;
based on the first cell being associated with the first network layer, the detection of the establishment cause, and a determination that a second cell associated with the second network layer is available, perform cell re-selection to the second cell; and
establish the connection via the second cell.

16. The WTRU of claim 15, wherein the establishment of the connection comprises establishing the connection or resuming the connection.

17. The WTRU of claim 15, wherein the establishment cause is related to at least one of: an emergency call; a mobile originated data call; a mobile originated voice call; or a mobile originated SMS.

18. The WTRU of claim 15, wherein the first network layer is associated with a non-terrestrial network (NTN) and the second network layer is associated with a terrestrial network (TN).

19. The WTRU of claim 15, wherein the processor is further configured to indicate, to a network associated with the second cell, the establishment cause.

20. The WTRU of claim 19, wherein the indication of the establishment cause is in: a setup or resume request message; a setup or resume complete message; or a Radio Resource Control (RRC) message.

21. The WTRU of claim 15, wherein the WTRU is in an RRC INACTIVE state or an RRC IDLE state at a time associated with the determination to establish the connection.

22. A method associated with a wireless transmit/receive unit (WTRU), the method comprising:
determining that the WTRU is associated with a first cell of a first network layer;
receiving configuration information, wherein the configuration information indicates that the first network layer is associated with a first connection cause and a second network layer is associated with a second connection cause;
determining to establish a connection based on a detection of an establishment cause, wherein the detected establishment cause is the second connection cause;
based on the first cell being associated with the first network layer, the detection of the establishment cause, and a determination that a second cell associated with the second network layer is available, performing cell re-selection to the second cell; and
establishing the connection via the second cell.

23. The method of claim 22, wherein the establishment of the connection comprises establishing the connection or resuming the connection.

24. The method of claim 22, wherein the establishment cause is related to at least one of: an emergency call; a mobile originated data call; a mobile originated voice call; or a mobile originated SMS.

25. The method of claim 22, wherein the first network layer is associated with a non-terrestrial network (NTN) and the second network layer is associated with a terrestrial network (TN).

26. The method of claim 22, further comprising:
indicating, to a network associated with the second cell, the establishment cause.

27. The method of claim 26, wherein the indication of the establishment cause is in: a setup or resume request message; a setup or resume complete message; or a Radio Resource Control (RRC) message.

28. The method of claim 22, wherein the WTRU is in an RRC INACTIVE state or an RRC IDLE state at a time associated with the determination to establish the connection.
